(19) United States
(12) Patent Application Publication
(10) Pub. No.: US 2011/0194243 A1
(43) Pub. Date: Aug. 11, 2011

(54) SERVER SYSTEM

(75) Inventors: Shou-Jen Yang, Taipei City (TW); Lian-Chang Du, Shanghai City (CN); Jing Chen, Shanghai City (CN)

(73) Assignee: INVENTEC CORPORATION, Taipei City (TW)

(21) Appl. No.: 12/773,433

(22) Filed: May 4, 2010

(30) Foreign Application Priority Data
Feb. 11, 2010 (CN) 201010111647.3

(51) Int. Cl. G06F 1/20; G06F 1/16

(52) U.S. Cl. 361/679.33; 361/679.48

(57) ABSTRACT

A server system including a case, a movable cover, a motherboard and a fan is provided. The case has a frontend, a backend opposite to the frontend, and a side surface perpendicular to the frontend and backend. The side surface has a first opening and the backend has a second opening. The movable cover includes a side plate and a back plate perpendicular to each other and is removably connected to the case. The side plate covers the first opening and the back plate covers the second opening. The motherboard is fixed to an inner side of the side plate, and the fan is fixed to an inner side of the back plate.

### CROSS-REFERENCE TO RELATED APPLICATION

This application claims the priority benefit of P.R.C. patent application serial no. 201010111647.3, filed on Feb. 11, 2010. The entirety of the above-mentioned patent application is hereby incorporated by reference herein and made a part of specification.

### BACKGROUND OF THE INVENTION

1. Field of the Invention

The present invention relates to a server system, and more particularly, to a server system that is convenient to use.

2. Description of Related Art

As people are relying more and more on computer systems, the market has an ever-increasing demand for high operational capability and data storage capacity of the computer systems. To protect these continuously improved electronic products such as desktop computers and servers, these electronic products are usually received in an enclosure, for example a case.

In fabrication of the conventional enclosures, a plate metal material is bent to form an outer casing and subsequently a side plate is assembled to the outer casing with screws to form the complete enclosure. Internal components, such as, a hard disk, a motherboard, a graphic card, are all mounted in this outer casing.

However, if a user needs to replace an internal component within the enclosure, he or she needs to detach the side plate from the outer casing completely. In general, since the side plate is mounted to the outer casing with screws, the user needs to use a hand tool such as a screw driver to remove the screws before detaching the side plate from the outer casing completely. If there is no hand tool on hand, the user would not be able to perform the detaching and assembling operations. In addition, during the course of detaching and assembling, screws may be missing. To the user, this can be very inconvenient.

### SUMMARY OF THE INVENTION

Accordingly, the present invention is directed to a server system that is convenient to use.

The present invention is also directed to a server system that is space-saving.

The present invention provides a server system including a case, a movable cover, a motherboard, and a fan. The case has a frontend, a backend opposite to the frontend, and a side surface perpendicular to both of the frontend and backend. The side surface has a first opening. The backend has a second opening. The movable cover is removably connected to the case. The movable cover includes a side plate and a back plate perpendicular to each other. The side plate covers the first opening, and the back plate covers the second opening. The motherboard is mounted to an inner side of the side plate. The fan is mounted to an inner side of the back plate. When the server system needs to be repaired or detached, the motherboard along with the side plate is separated from the case via the movable cover open, and thus the repair man can conveniently perform the repairing operations.

According to one embodiment of the server system, the server system further includes a hard disk module disposed at the frontend of the case. A first space is formed between the hard disk module and the side plate, a second space is formed between the hard disk module and a top of the case, and a third space is formed between the hard disk module and the backend of the case. The hard disk module includes a plurality of hard disk signal ports connected to the motherboard via cables extending through the third space. In addition, the motherboard is disposed in the first space. The server system further comprises at least one expansion card perpendicularly connected to the motherboard and extending into the second space, and one end of the expansion card is secured to the back plate. Besides, the fan is disposed in the third space for cooling the motherboard and the hard disk module. The main components of the server system are compactly arranged in the case in an interlacing manner and the space utilization rate is very high, such that the server system size can be made very small. Furthermore, a power on/off module is disposed at the frontend of the case, and the power on/off module is connected to the motherboard via a cable extending through the first space. Moreover, at least one USB port is disposed at the frontend of the case, and the USB port is connected to the motherboard via a cable extending through the first space.

According to one embodiment of the server system, the motherboard includes a direct current power port exposed out of the back plate, and the server system further comprises an external power adapter connected to the direct current power port to transform an external alternating current power into a direct current power to power the server system. That the power supply is disposed externally further saves the internal space of the server system.

According to one embodiment of the server system, a pivot axle is disposed at a bottom of the side plate and is connected to a bottom of the case to pivotably connect the movable cover to the case. A reverse hook clasp is disposed at one side of a bottom plate of the case, and the pivot axle of the side plate surrounds a portion of the reverse hook clasp. In addition, the side plate includes a hook at a top thereof, the case has a hooking slot positioned in correspondence with the hook, and the hook is engaged in the hooking slot. Besides, the case further includes a latch constraining the hooking slot when the hook is engaged in the hooking slot. In view of the foregoing, the movable cover of the server system can be opened relative to the case in a pivoting manner. Therefore, it is more comfortable and convenient for the user to open the server system when compared against the prior art.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 illustrates a server system in an opened state.

FIG. 2 illustrates the server system of FIG. 1 in a closed state.

FIG. 3 is another view of the sever system in FIG. 2.

FIG. 4 and FIG. 5 are left side and right side views of the server system, respectively.

FIG. 6A is an exploded view of the motherboard, an expansion card, a fan, and the movable cover.

FIG. 6B is an assembled view of the motherboard, the expansion card, the fan, and the movable cover.

FIG. 7 illustrates the movable cover in an opened state relative to the case.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purposes of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

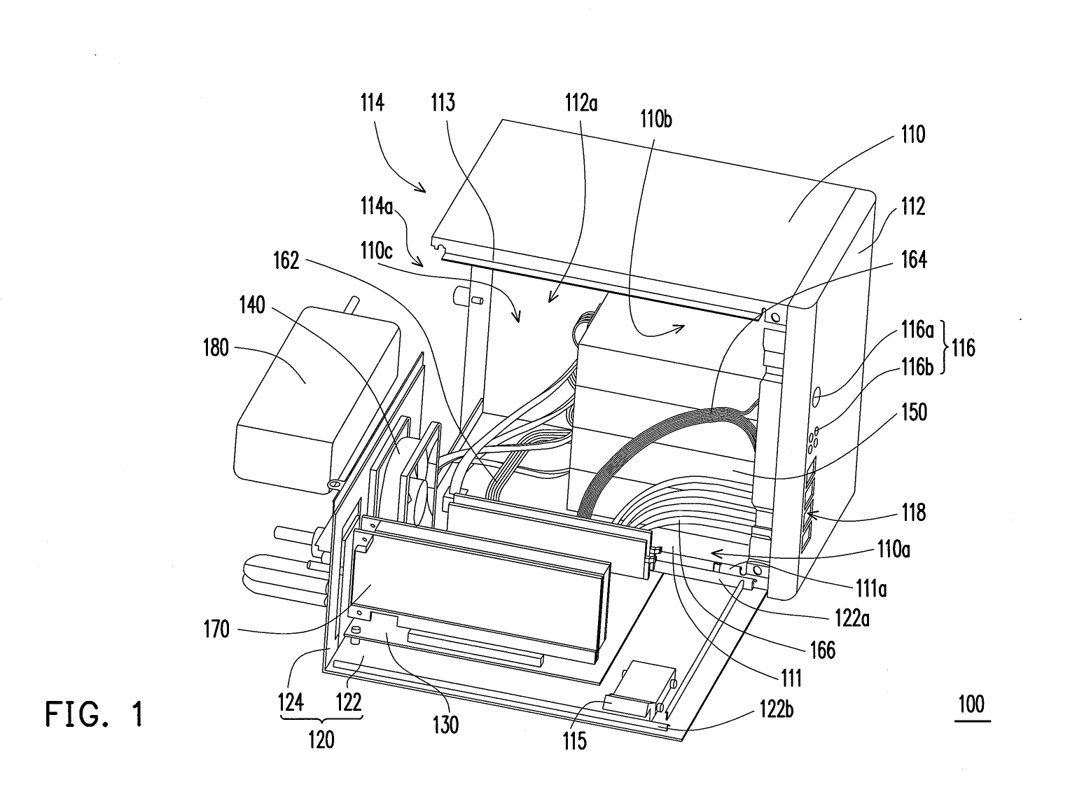

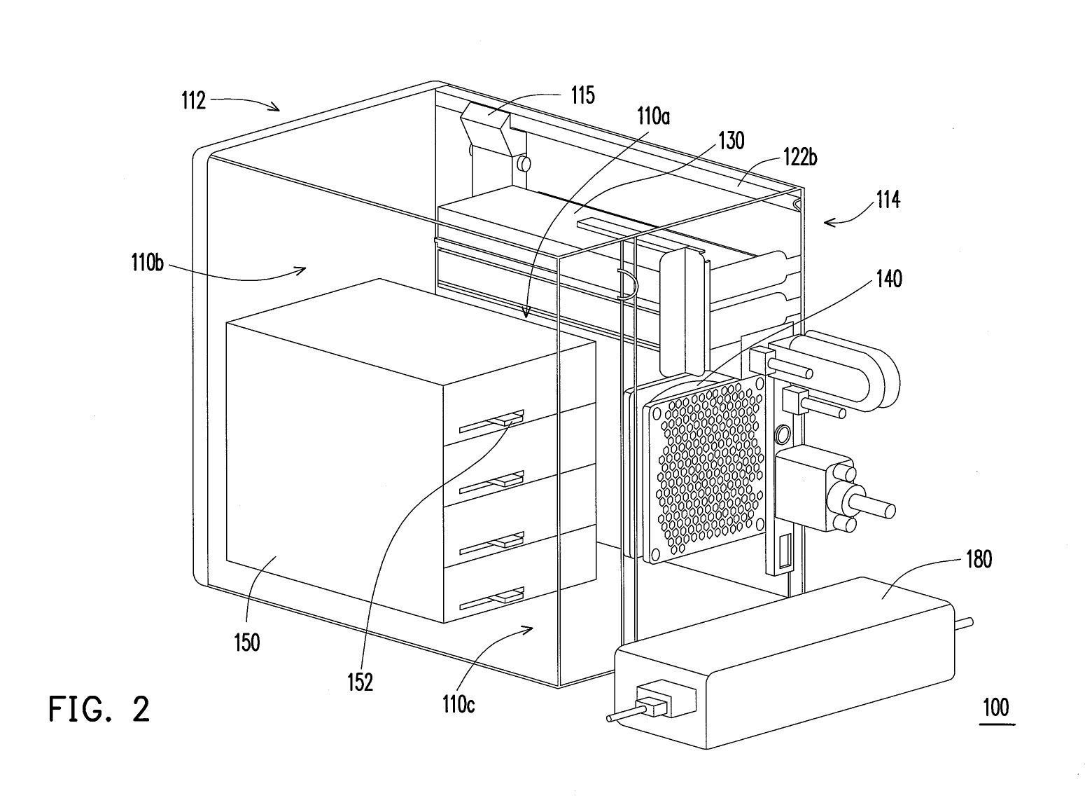

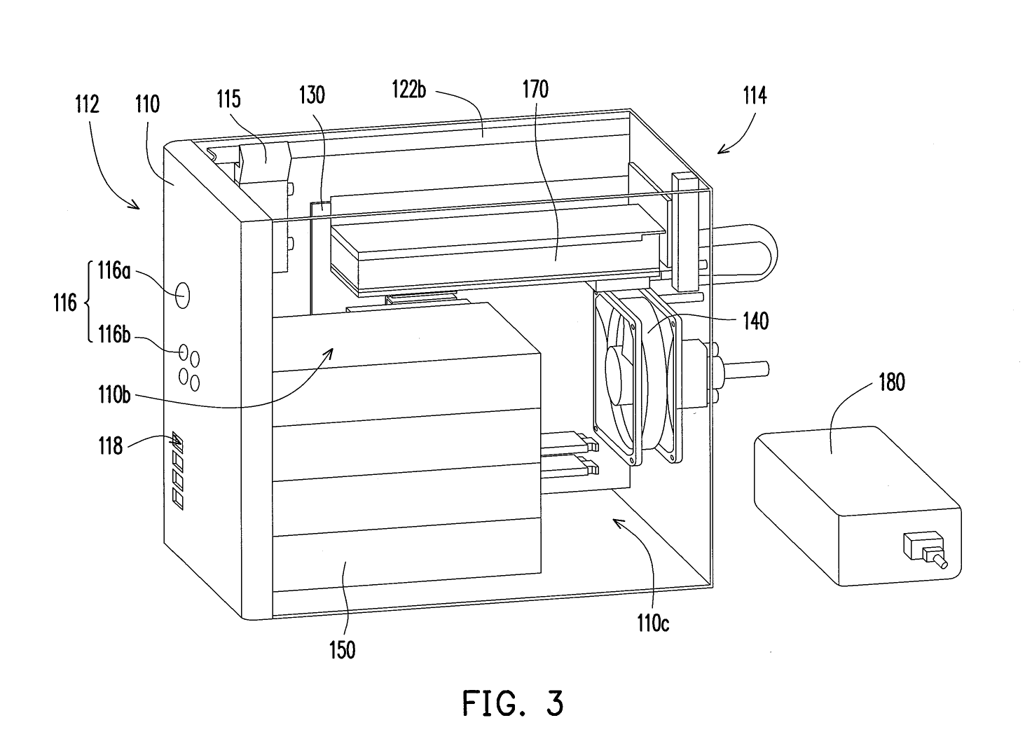

FIG. 1 illustrates a server system in an opened state. FIG. 2 illustrates the server system in a closed state. FIG. 3 is another view of the sever system in FIG. 2. FIGS. 1, 2 and 3 are views of the server system from different angles. In addition, portions of the case of FIG. 2 and FIG. 3 are depicted as being transparent in order to show internal components of the server system. Referring to FIGS. 1, 2 and 3, the server system 100 includes a case 110, a movable cover 120, a motherboard 130, and a fan 140. The case 110 includes opposite frontend 112 and backend 114 that are positioned in substantially parallel with each other. The case 110 further includes a side surface (not shown) perpendicularly connected to the frontend 112 and backend 114. The side surface (not shown) has a first opening 112a and the backend 114 has a second opening 114a. The movable cover 120 is removably connected to the case 110. The movable cover 120 includes a side plate 122 and a back plate 124 that are perpendicular to each other. After the server system 100 is assembled, the side plate 122 covers the first opening 112a and the back plate 124 covers the second opening 114a. The motherboard 130 is fixed to an inner side of the side plate 122. The fan 140 is fixed to an inner side of the back plate 124. With the removable connection between the case 110 and the movable cover 120, the user can conveniently open the movable cover 120 to expose components inside the case 110, e.g. the motherboard 130 or fan 140, thus facilitating replacement or repairment of these components. Therefore, the server system 100 is convenient to use.

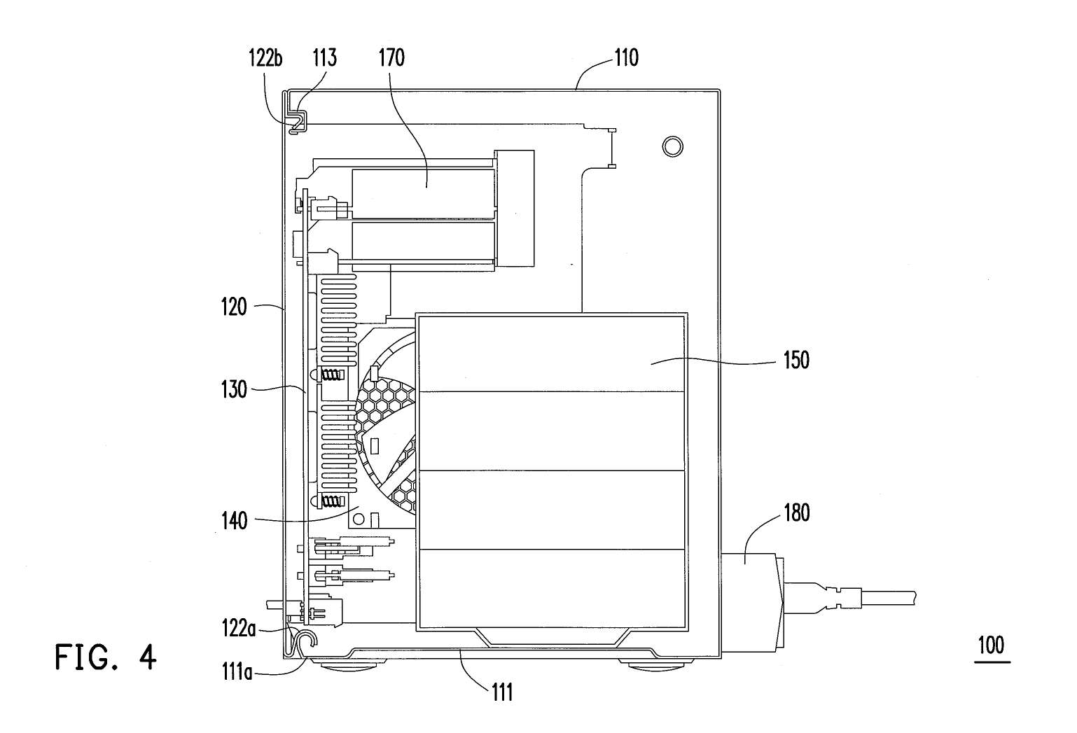

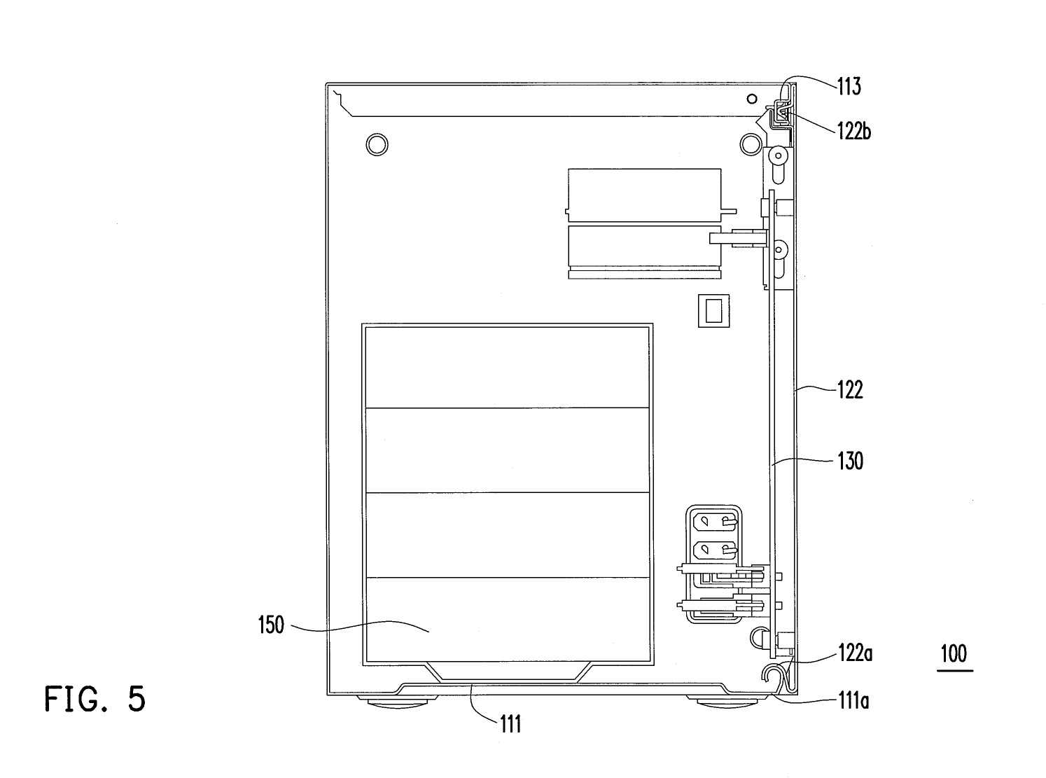

FIG. 4 and FIG. 5 are left side and right side views of the server system, respectively. The case and the side plate of the movable cover are depicted as being transparent in order to clearly show the server system 100. Referring to FIGS. 4 and 5, a bottom of the side plate 122 includes a pivot axle 122a connected to a bottom of the case 110 to pivotably connect the movable cover 120 to the case 110. More specifically, one side of a bottom plate 111 of the case 110 is bent to form a generally C-shaped reverse hook clasp 111a, and one side of the side plate 122 may also be bent to form the generally S-shaped pivot axle 122a. The S-shaped pivot axle 122a surrounds and clasps at least a portion of the reverse hook clasp 111a. The generally C-shaped reverse hook clasp 111a and the generally S-shaped pivot axle 122a are for the purposes of illustration only and therefore should not be regarded as limiting. Rather, they can be constructed in a different manner according to actual requirements. For example, the pivot axle 122a may also be a cylinder inserted into the generally C-shaped reverse hook clasp 111a.

The side plate 122 includes a hook 122b which may also be formed by bending one side of the side plate 122. The case 110 forms a hooking slot 113 positioned in correspondence with the hook 122b. This hooking slot 113 is also engaged with the hook 122b. In addition, the case 110 may further include a latch 115 for constraining the hooking slot 113 once the hook 122b is engaged in the hooking slot 113. Because the side plate 122 and the back plate 124 are formed into a unitary structure, the movable cover 120 may be stably connected to the case 110 with the engagement among the hook 122b, hooking slot 113 and latch 115. The back plate 124 may further be provided with screw holes (not shown) and therefore mounted to a flange (not shown) on the backend 114 of the case 110 with screws (not shown) thus strengthening the mounting of the movable cover 120.

With continuous reference to FIGS. 1, 2, and 3, the server system 100 further includes a hard disk module 150 disposed at the frontend 112 of the case 110. A first space 110a is formed between the hard disk module 150 and the side plate 122, a second space 110b is formed between the hard disk module 150 and a top of the case 110, and a third space 110c is formed between the hard disk module 150 and the backend of the case 110. The hard disk module 150 has a plurality of hard disk signal ports 152. These signal ports 152 are connected to the motherboard 130 in the first space 110a via cables 162 extending through the third space 110c, respectively.

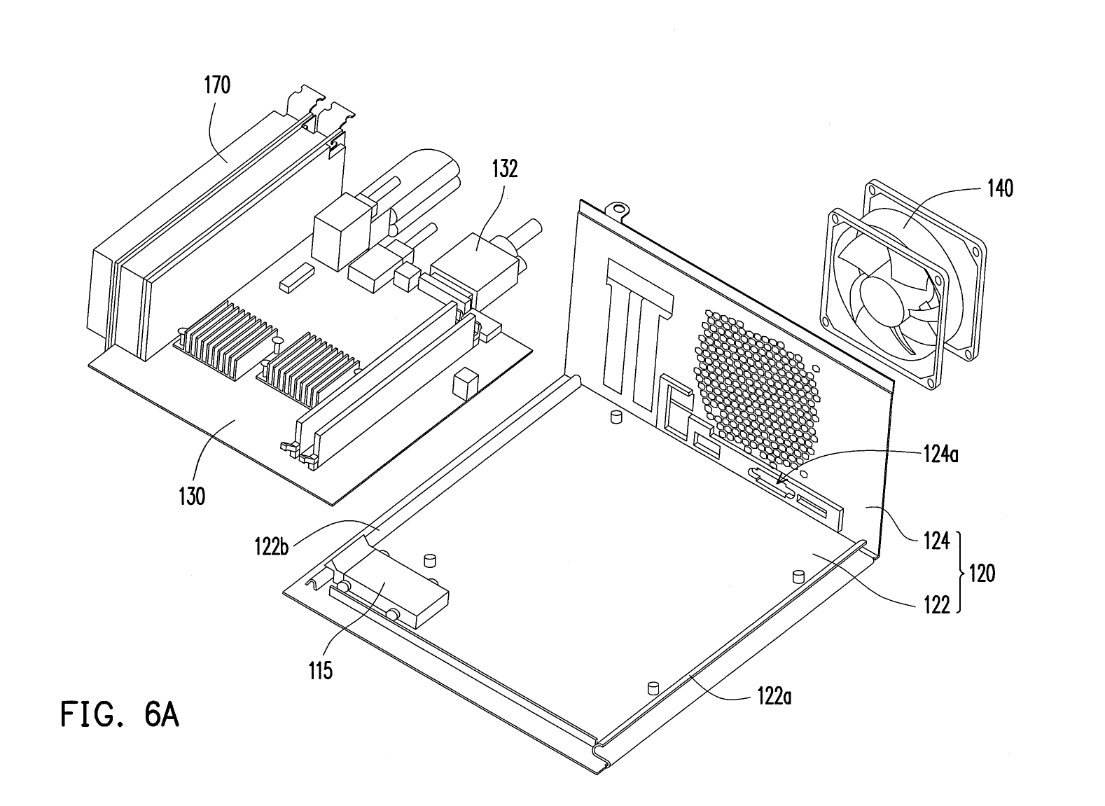

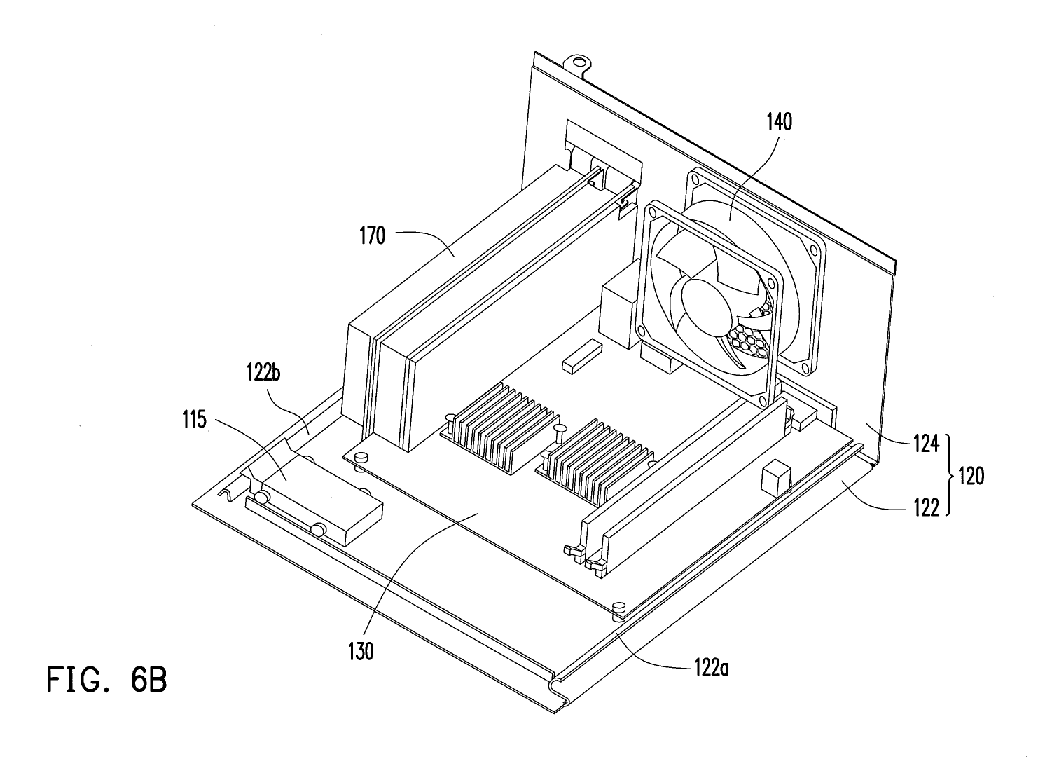

FIG. 6A is an exploded view of the motherboard, an expansion card, a fan, and the movable cover, and FIG. 6B is an assembled view of the motherboard, the expansion card, the fan, and the movable cover. Referring to FIGS. 1, 6A and 6B, the server system 100 further includes at least one expansion card 170 perpendicularly connected to the motherboard 130 and extending into the second space 110b. One end of the expansion card 170 is secured to the back plate 124. In addition, the fan 140 is disposed in the third space 110c for cooling the motherboard 130 and the hard disk module 150.

Referring to FIGS. 1 and 3, a power on/off module 116 is disposed at the frontend 112 of the case 110. The power on/off module 116 is connected to the motherboard 130 via cables 164 extending through the first space 110a. The power on/off module 116 includes a power on/off button 116a and an indicator 116b. In addition, at least one USB port 118 (four ports are illustrated in the drawing) is disposed at the frontend 112 of the case 110. The USB ports 118 are connected to the motherboard 130 via cables 166 extending through the first space 110a, respectively. As described above, the hard disk module 150, power on/off module 116 and USB ports 118 are all connected to the motherboard 130 via cables. As such, when the movable cover 120 is detached during repairing or debugging, the server system 100 can still work normally without affecting the communication.

Referring to FIGS. 2 and 6A, the motherboard 130 includes a direct current power port 132 that is exposed through an opening 124a of the back plate 124. The server system 100 further includes an external power adapter 180 connected to the direct current power port 132.

Referring to FIG. 2, when the server system 100 is used, the external power adapter 180 connected to the direct current power port 132 of the motherboard 130 transforms an external alternating current power into a direct current power to power the server system 100. In this case, a user may press the power button 116a of the power on/off module 116 to power on the server system 100 and observe the power on/off status of the server system 100 via the indicator 116b. When the server system 100 is in a using state, data exchange occurs between the hard disk module 150 and the motherboard 130. The hard disk module 150 and the motherboard 130 generates heat during operation, and the fan 140 disposed in the third space 110c is used to cool the motherboard 130 and hard disk module 150.

It is noted that, due to the use of the external power adapter 180, it is possible to free up some of the internal space of the case 110 if the overall size of the server system 100 is not reduced; otherwise, the overall size of the server system 100 can be reduced. In addition, relative to the hard disk module 150, the motherboard 130 is disposed in the first space 110a between the hard disk module 150 and the side plate 122, the expansion cards 170 are disposed in the second space 110b between the hard disk module 150 and the top of the case 110, and the fan 140 is disposed in the third space 110c between the hard disk module 150 and the backend of the case 110. In other words, the internal electronic components of the server system 100 are well received in respective sub-spaces that are obtained by dividing the space between the case 110 and the movable cover 120 by the hard disk module 150, and there are spare spaces for cables 162, 164 and 166. It is unnecessary to specially design spaces for receiving these internal electronic components in the space between the case 110 and movable cover 120 of the server system 100 when they are closed. Therefore, the internal space of the server system 100 can be efficiently used.

Moreover, the hard disk module 150 is disposed at a lower portion of the frontend 112 of the case 110, which can balance the weight of the other side of the server system 100, such that the server system 100 can be prevented from falling down due to weight unbalance during move.

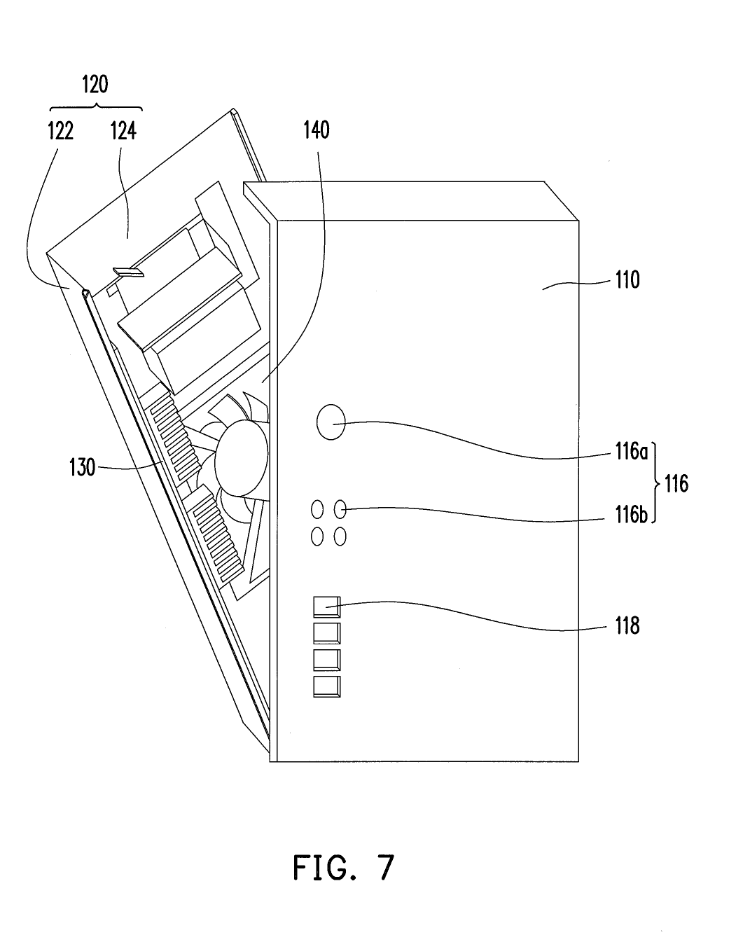

FIG. 7 illustrates the movable cover in an opened state relative to the case. Referring to FIGS. 1 and 7, in particular, through the clasp engagement between the pivot axle 122a at the bottom of the side plate 122 of the movable cover 120 and the reverse hook clasp 111a at one side of the bottom plate 110 of the case 110, the movable cover 120 may be opened relative to the case 110 by pivoting about the pivot axle 122a and, after being opened, the movable cover 120 is still connected with the case 110 and not separated completely. Therefore, the user can conveniently open the movable cover 120 relative to the case 100 without the need of any hand tool.

In addition, after the movable cover 120 is opened relative to the case 110, the motherboard 130, expansion cards 170, and cables 162, 164, 166 can thus be seen. Therefore, it is easy for a user to plug or remove components or expansion cards 170 for replacement as well as adjust cables 162, 164, 166.

In summary, the present server system at least has the following advantages:

1. Through the clasp engagement of the hook of the top of the movable cover into the hooking slot of the top of the case, the user can conveniently open the movable cover relative to the case without the need of any hand tool.

2. Through the clasp engagement between the pivot axle of the bottom of the movable cover and the reverse hook clasp of the bottom of the case, the user can open the movable cover relative to the case in a pivoting manner, which is different from the prior art in which the user would need to use a hand tool to detach the whole side plate from the case.

3. After the movable cover is opened relative to the case, the user can replace, repair or adjust the internal components disposed within the case, such as, the motherboard, components on the motherboard, expansion cards, cables, or fan.

4. By disposing the power adapter outside the case, it is possible to free up some of the internal space of the case when the overall size of the server system is not reduced, or the overall size of the server system can be reduced, thus reducing the fabrication cost.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A server system comprising:
a case having a frontend, a backend opposite to the frontend, and a side surface perpendicular to both of the frontend and backend, the side surface having a first opening, the backend having a second opening;
a movable cover removably connected to the case, the movable cover including a side plate and a back plate perpendicular to each other, the side plate covering the first opening, the back plate covering the second opening;
a motherboard fixed to an inner side of the side plate; and
a fan fixed to an inner side of the back plate.

2. The server system according to claim 1, further comprising a hard disk module disposed at the frontend of the case, wherein a first space is formed between the hard disk module and the side plate, a second space is formed between the hard disk module and a top of the case, and a third space is formed between the hard disk module and the backend of the case.

3. The server system according to claim 2, wherein the hard disk module includes a plurality of hard disk signal ports connected to the motherboard via cables extending through the third space.

4. The server system according to claim 2, wherein the motherboard is disposed in the first space, the server system further comprises at least one expansion card perpendicularly connected to the motherboard and extending into the second space, and one end of the expansion card is secured to the back plate.

5. The server system according to claim 2, wherein the fan is disposed in the third space for cooling the motherboard and the hard disk module.

6. The server system according to claim 1, wherein the motherboard includes a direct current power port exposed out of the back plate, and the server system further comprises an external power adapter connected to the direct current power port to transform an external alternating current power into a direct current power to power the server system.

7. The server system according to claim 2, wherein a power on/off module is disposed at the frontend of the case, and the power on/off module is connected to the motherboard via a cable extending through the first space.

8. The server system according to claim 7, wherein the power on/off module includes a power on/off button for controlling power on or off of the server system and an indicator for indicating the operating status of the server system.

9. The server system according to claim 2, wherein at least one USB port is disposed at the frontend of the case, and the USB port is connected to the motherboard via a cable extending through the first space.

10. The server system according to claim 1, wherein a pivot axle is disposed at a bottom of the side plate and is connected to a bottom of the case to pivotably connect the movable cover to the case.

11. The server system according to claim 10, wherein a reverse hook clasp is disposed at one side of a bottom plate of the case, and the pivot axle of the side plate surrounds a portion of the reverse hook clasp.

12. The server system according to claim 1, wherein the side plate includes a hook at a top thereof, the case has a hooking slot positioned in correspondence with the hook, and the hook is engaged in the hooking slot.

13. The server system according to claim 11, wherein the case further includes a latch constraining the hooking slot when the hook is engaged in the hooking slot.
